(19) United States
(12) Patent Application Publication
(10) Pub. No.: US 2021/0270022 A1
(43) Pub. Date: Sep. 2, 2021

(54) Sewage Backup Prevention Device

(71) Applicant: Dennis Dowling, Baytown, TX (US)

(72) Inventor: Dennis Dowling, Baytown, TX (US)

(21) Appl. No.: 17/185,540

(22) Filed: Feb. 25, 2021

Related U.S. Application Data
(60) Provisional application No. 62/982,775, filed on Feb. 28, 2020.

(51) Int. Cl. E03C 1/232

(52) U.S. Cl. CPC E03C 1/232

(57) ABSTRACT

A sewage backup prevention system is disclosed that enables an amount of sewage to exit an opening in a sewer cleanout instead of backing up into a finished portion of a residence or other building. The sewage backup prevention cap has a tapered body, contains no threads and fits loosely around and partially in a branch opening in the sewer cleanout. A backup in the sewer line will cause the sewage backup prevention cap to move upwardly from the branch opening thereby allowing an increasing amount of sewage to exit the sewer line.

### CROSS-REFERENCE TO RELATED APPLICATION

The present application claims priority to, and the benefit of, U.S. Provisional Application No. 62/982,775, which was filed on Feb. 28, 2020 and is incorporated herein by reference in its entirety.

### FIELD OF THE INVENTION

The present invention relates generally to the field of fluid control valves. More specifically, the present invention relates to a cap closure for a sewage cleaning connection that prevents excessive sewage backup by allowing a portion of the backup flow to be relieved via the device. The cap closure comprises no threads and fits loosely over the top of the sewer “T” connection. The cap closure structure features an integrated air pocket that enables the cap to “float” within the connection, and enables the periodic release of a relatively small amount of sewage during a backup to prevent an excessive sewage overflow. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, sewer backups are a frequent occurrence in the plumbing world, and can cause significant damage when they occur. Generally stated, a sewer backup occurs whenever something blocks the normal flow of waste or wastewater in the sewer pipe connecting a home or other structure to the city's sanitary sewer, a septic field, holding tank, etc., and the sewage starts to backup into the home or structure. Sewer backups may be triggered by any number of different factors such as, but not limited to, a blockage in the sewer pipe caused by tree roots, items flushed down a toilet or any other foreign object of debris, construction mishaps, plumbing system deterioration, heavy rains or the like. Sewage backups may also cause other related issues such as noxious odors, severe water damage, etc. Additionally, sewage backups represent a significant health threat, since the contents of a sewer system contain human and other biological waste, and are typically heavily contaminated with bacteria, disease and other harmful microbes and pathogens.

Various sewage backup prevention devices are currently available to prevent or at least reduce the likelihood of a sewage backup entering into a home or building. For example, sewage backup prevention devices, such as check valves, are oftentimes installed along a sewer line to prevent a sewage backup. Unfortunately, sewer check valves do not completely prevent backwater, and are only ideal for short-term backups typically lasting less than a full day. Other backup prevention valves may also be used and installed along a sewer line to prevent the sewage from flowing back towards its point of origin, but such valves typically only prevent backups originating from the main sewer line, and not from a branch line, such as those running to a house or business. Still other sewage backflow prevention devices are available, such as a hose bib, pressure type vacuum breakers, etc. However, installation of these types of backflow prevention devices may be complicated and should only be performed by an experienced plumber or technician. This can be both expensive and time consuming and may still fail to adequately prevent a sewage backup.

Because sewage backups are a fairly common occurrence, many plumbers, homeowners and others will have a clean-out installed along the sewer line to allow for periodic preventative maintenance of the sewer line, such as auguring out roots that may infiltrate the line at junctions or simply cleaning out scale build-up and partial clogs from the sewer line. Typically, standard sewage cleanouts are in a “T” configuration wherein the straight leg will be in-line with the sewer line and the branch will be angled (i.e., perpendicular) thereto, wherein the branch will have a screw on cap that is secured thereto. When the cap or valve is firmly secured to the cleanout, the sewage cannot exit the same in the event of a backup, and having nowhere else to go, will then backup to its point of origin and leak into the home or building and to be discharged at the lowest sewer access point. In such scenarios, sewage flow into a building will ruin carpet, wood and other flooring, requiring extensive repairs and replacements.

Therefore, there exists a long felt need in the art for a sewage backup prevention device that prevents or reduces the likelihood of a significant sewage backup into a home or other building having a sewer line, and therefore prevents carpet, wood and other flooring from being ruined and requiring extensive repairs and replacements. There is also a long felt need in the art for a sewage backup prevention device that can be used with an existing “T” shaped cleanout, thereby not requiring significant or time consuming modifications to an existing sewer line, or experienced plumbers or technician for installation of the backup prevention device. Additionally, there is a long felt need in the art for a “T” shaped sewage backup prevention device which is easily installable in new construction, and that eliminates the need to screw and unscrew the cleanout cap or valve. Finally, there is a long felt need in the art for a sewage backup prevention device that is relatively inexpensive to manufacture, offers unobstructed sewage flow through a sewer line and that is both safe and easy to use.

The subject matter disclosed and claimed herein, in one embodiment thereof, comprises a novel sewage backup prevention cap device designed to loosely fit around the top of a “T” shaped sewer connection or cleanout. More specifically, the cap device is comprised of a tapered body portion having a wider upper end and a narrower bottom end (wherein the bottom end refers to the portion of the tapered body portion that rests further into the “T” shaped cleanout), a top portion having an annulus and an integrated air pocket. In use, the cap device rests (via gravity) in the branch opening of the “T” shaped cleanout, wherein the integrated air pocket helps to center the body portion in the opening. Then, when sewage begins to backup in the sewer line and into the branch of the “T” shaped cleanout, the free floating cap will begin to float upward as if leaving the branch opening¹. Because of the tapered shape of the body portion, the further the cap floats upward, the more volume of sewage that is permitted to exit the “T” shaped cleanout between the branch and the tapered wall, as opposed to backing up into a finished portion of the house or building where significant damage may occur.² For example, it is anticipated that the cap may be completely displaced if the restriction in the sewer line is sufficiently large. Likewise, when the sewage level in the sewer line recedes, the floating cap will drop back down into the branch opening, such that the annular top portion will again rest on the cleanout and prevent gases from emanating therefrom. ¹Dennis: What prevents the cap from being blown out of the T? Should there be some mechanism on the cap that prevents the cap from being fully removed (e.g., a cage like device that can be positioned over the free floating cap and that snaps onto the cleanout to prevent the cap from fully leaving the cleanout opening)?²Dennis: What about this mess that is created? Is the thought simply that the cleanout will be positioned in an unfinished portion of the house or building where less damage will occur? Also, because there is no seal, what prevents the odors from always escaping the pipe and permeating the house or building? Also, have you researched whether the plumbing and health codes would permit such a loose fitting (if not, you likely wont have any buyers)?

In this manner, the novel sewage backup prevention cap of the present invention accomplishes all of the forgoing objectives, and provides a relatively safe, easy, convenient and cost-effective solution that enables a sewage backflow to exit the pipe system periodically, before backing up into a residential, commercial, or industrial plumbing area where the same may cause significantly more damage. The sewage backup prevention cap of the present invention is also user friendly, inasmuch as it is far less expensive than its alternatives, and does not require any professional assistance to install the cap into a sewer cleanout device for sewage backup prevention.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel sewage backup prevention cap designed to loosely fit around and partially into the top of a sewer “T” connection or cleanout. The cap comprises an annular top portion positioned atop or integrally formed with a tapered body portion having an integrated air pocket, a wider upper portion and a narrower lower portion. In use, the tapered body portion is inserted into a branch opening in an existing “T” shaped sewer connection or cleanout, wherein the annular top portion is larger than the branch opening so that it rests thereon (via gravity, and is not threaded or otherwise fixedly attached to the cleanout) with the tapered body portion extending down into the branch opening. The presence of the integrated air pocket helps the cap device to center within the opening.³ Further, in the event of a sewage backup or heavy flow in the line, the presence of the air pocket will also cause the cap to be floated upward. As the cap floats upward, the taper of the body portion will increase the opening between the cleanout and the cap device (or blow it out of the cleanout altogether) to permit an increasing amount of sewage to exit the pipe at the cleanout, as opposed to a finished portion of the house or building. Similarly, and assuming that the cap is not blown off the cleanout altogether, once the sewage recedes in the sewer line, the cap will again fall back into place until the next sewage backup. ³ Dennis: How? Also, wont the sewage flow in one direction naturally cause it to not center (i.e., because its being pushed or drawn in the direction of the flow)?

The subject matter disclosed and claimed herein, in another embodiment thereof, comprises a plumbing system attachment that provides both a convenient access point for the user to periodically clean out the sewer line (e.g., of tree roots or other blockages) and that also provides an emergency point of egress for a sewage backflow before it backs up into a finished point of the residence or other building. The plumbing system attachment is comprised of a generally “T” shaped cleanout or sewer connection device, and a unique and novel cap for use therewith. The “T” shaped cleanout may be installed in line with an existing sewer line, as is known in the art. However, instead of screwing a traditional cap into the branch of the “T” shaped connector that is generally perpendicular to the sewer line, the user would instead install the novel cap. As explained above, the novel cap comprises an annular top portion positioned atop or integrally formed with a tapered body portion having an integrated air pocket, a wider upper portion and a narrower lower portion. In use, the tapered body portion is inserted into the branch opening of the “T” shaped cleanout, wherein the annular top portion rests thereon with the tapered body portion extending down into the branch opening. In the event of a sewage backup in the line, the presence of the air pocket will cause the cap to be floated upward and the taper of the body portion will increase the opening between the cleanout and the cap device to permit an increasing amount of sewage to exit the pipe at the cleanout, as opposed to a finished portion of the house or building.

In a further embodiment of the present invention, the sewage backflow stop cap of the present invention may further comprise a wire mesh frame or cage that can be removably attached to the branch of the “T” shaped cleanout and over the cap loosely installed therein to limit the upward movement of the novel cap during a sewage backup event. More specifically, the wire cage would provide ample space for the novel cap to rise up in the branch opening in the event of a sewage backup to allow the backed up sewage to flow through the opening created by the tapered body portion of the cap and the interior of the branch so that the sewage does not also backup into the finished portion of the house or other building. However, the spacing between the wire cage and the top surface of the novel cap would be such that the cap could not be completely discharged from the branch opening. Therefore, when the sewer backup recedes, the cap would naturally float (i.e., via gravity) downwardly and back into the branch opening until the next sewer backup event.

In yet another embodiment of the present invention, the sewage backup prevention device may further comprise a battery powered sensor positioned along a top surface of the novel cap. The sensor would be capable of sensing movement of the cap and may further comprise a transmitter that is in wireless communication with a smart device, such as a smartphone having a mobile application. Therefore, when a sewage backup occurs that causes the novel cap to reposition upward within the “T” shaped branch opening, the sensor, upon sensing the upward motion of the cap, could trigger the transmitter to issue an alert to the user's smart device so that the user can begin to take corrective action before the sewage backup extends into the finished portion of the house or other building.

The sewage backup prevention attachment in the form of a loosely fitted cap of the present invention is advantageous as the cap offers unobstructed flow while ensuring foreign material is unable to enter the sewer line since the top opening of the “T” shaped connection/cleanout remains closed until access is required. The novel cap attachment also eliminates the need to screw and unscrew the cap onto the “T” shaped connection/cleanout, and permits a relatively small amount of sewage to be released from the sewer line in a somewhat controlled manner during a backup as opposed to backing up into a finished portion of a house or other building where the same may cause considerable damage. Further, the user can easily install the cap without any professional assistance, which could be both costly and time consuming.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the sewage backup prevention cap of the present invention in accordance with the disclosed architecture;

FIG. 2 illustrates a bottom perspective view of one potential embodiment of the sewage backup prevention cap of the present invention in accordance with the disclosed architecture;

FIG. 3 illustrates a perspective view of one potential embodiment of the sewage backup prevention cap of the present invention in accordance with the disclosed architecture, wherein the sewage backup prevention cap is about to be loosely installed in a “T” shaped sewer connection or cleanout;

FIG. 4 illustrates a cross-sectional view of one potential embodiment of the sewage backup prevention cap of the present invention in accordance with the disclosed architecture, wherein the sewage backup prevention cap is loosely installed in a “T” shaped sewer connection or cleanout containing a flow of sewage therein;

FIG. 5 illustrates a partial cross-sectional view of one potential embodiment of the sewage backup prevention cap of the present invention in accordance with the disclosed architecture, wherein the entire sewage backup prevention cap is shown to be loosely installed in a cross-sectioned “T” shaped sewer cleanout and a cross sectioned motion limiting cage is attached to a branch of the cleanout over top of the sewage backup prevention cap; and

FIG. 6 illustrates a perspective view of one potential embodiment of the sewage backup prevention cap of the present invention in accordance with the disclosed architecture, wherein the sewage backup prevention cap is loosely installed in a “T” shaped sewer cleanout installed along a sewer line, and further wherein a sensor is positioned on a top surface of the sewage backup prevention cap that is in wireless communication with a remote smart device.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a sewage backup prevention device that prevents or reduces the likelihood of a sewage backup into a home or other building having a sewer line, and therefore prevents carpet, wood and other flooring from being ruined and requiring extensive repairs and replacements. There is also a long felt need in the art for a sewage backup prevention device that can be used with an existing “T” shaped sewer cleanout, thereby not requiring significant or time consuming modifications to an existing sewer line, or experienced plumbers or technician for installation of the backup prevention device. Additionally, there is a long felt need in the art for a generally “T” shaped sewage backup prevention device which is easily installable in new construction, and that eliminates the need to screw and unscrew the cleanout cap or valve to access the cleanout. Finally, there is a long felt need in the art for a sewage backup prevention device that is relatively inexpensive to manufacture, offers unobstructed sewage flow through a sewer line and that is both safe and easy to use.

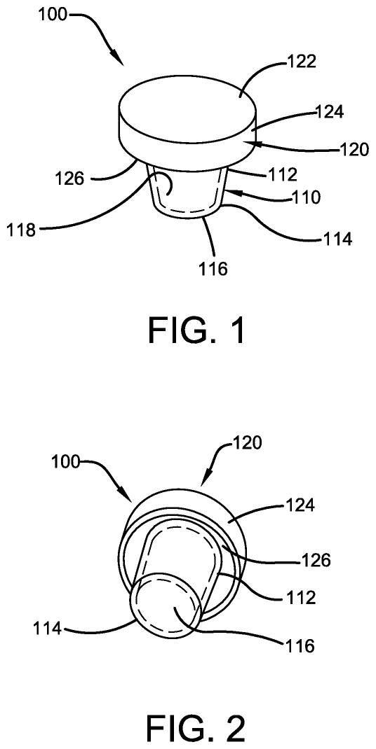

Referring initially to the drawings, FIG. 1 illustrates a perspective view of one potential embodiment of the sewage backup prevention cap 100 of the present invention in accordance with the disclosed architecture. More specifically, the sewage backup prevention cap 100 is comprised of a body portion 110 and a top ring portion 120. The body portion 110 and the top ring portion 120 are preferably integrally formed but are not required to be, and the body portion 110 may be fixedly or removably attached to the top ring portion 120 by any suitable means, such as an adhesive, threading, fasteners etc.

The body portion 110 is generally cylindrical in shape but tapered in diameter, and is comprised of a larger upper end 112, a narrower bottom end 114, a bottom surface 116 and an integrated air pocket 118, as best shown in FIGS. 1 and 2. More specifically, the body portion 110 extends downwardly from the top ring portion 120, which is comprised of a top surface 122, a side surface 124 and a bottom surface 126. The diameter of the top ring portion 120 is larger than the diameter of the upper end 112 of the body portion 110 so that the bottom surface 126 of the top ring portion 120 extends outwardly from the upper end 112 of the body portion 110 around its entire circumference and rests on the sewer cleanout connection 300, as described more fully below. Similarly, the diameter of the upper end 112 of the body portion 110 is larger than the diameter of the lower end 114 of the body portion 110.

The top ring portion 120 is generally wider than the opening 312 of the sewage pipe cleanout 300 so that it is capable of resting thereon with the body portion 110 extending down into the opening 312, thus enabling a relatively loose fit between the two. No portion of the cap 100 device has any threads for mating engagement with the pipe cleanout 300 and the same is not affixed to the cleanout 300, thereby eliminating the screwing and unscrewing operation associated with prior art cleanout caps for attachment and removal and to access the interior of the sewer line.

Similar to the body portion 110, the integrated air pocket 118 contained within the body portion 110 is also tapered, and helps to center the cap device 100 within the opening 312 of the sewer cleanout 300. More specifically, the integrated air pocket 118 is wider near the upper end 112 of body portion 110, and narrower near the lower end 114 of the body portion 110. The integrated air pocket 118 allows the sewer cap device 100 to float in the top opening 312 of the sewage connection device 300 when the sewer line begins to fill with waste, for example, as part of a backup. More particularly, the presence of the air pocket 118 will cause the cap 100 to be floated upward and the taper of the body portion 110 will increase the opening between the branch leg 310 of the cleanout device 300 and the cap device 100 to permit an increasing amount of sewage to exit the sewer pipe at the cleanout 300, as opposed to backing up into a finished portion of a house or building.

As noted, the cap device 100 is designed to freely sit on top of opening 312 of the sewer “T” connector 300, wherein the top ring portion 120 is positioned outside and slightly above the branch opening 312, and the body portion 110 extends downwardly therefrom into the opening 312. The cap device 100 is preferably comprised of a relatively lightweight and low-density polyethylene (LDPE), PVC or ABS plastic with enough flex to ensure a loose fit between the cap device 100 and the sewer cleanout 300. Notwithstanding, the cap device 100 is not so limited and may also be comprised of other suitable materials provided that the same exhibit excellent strength, sufficient impact resistance and good chemical resistance. The cap 100 may also be made available in a large variety of sizes to suit various pipe materials and openings, and so that the body portion 110 of the cap device 100 can fit into a variety of unthreaded and threaded openings 312 of the sewage cleanout 300.

FIG. 2 illustrates a bottom perspective view of one potential embodiment of the sewage backup prevention cap 100 of the present invention in accordance with the disclosed architecture. As shown, both the body portion 110 and its integrated air pocket 118 are tapered from a larger upper end 112 to a smaller lower end 114 so that when the water/sewage level rises in the sewer line (e.g., due to a back-up), the cap 100 will float upwards (i.e., away from the sewer line) to create a larger and larger gap between the body portion and the branch 310 of the cleanout 300 to release increasing quantities of fluid/sewage therethrough. Similarly, gravity will cause the cap device 100 to drop back down into the opening 312 once the level of water/sewage in the sewer line recedes.

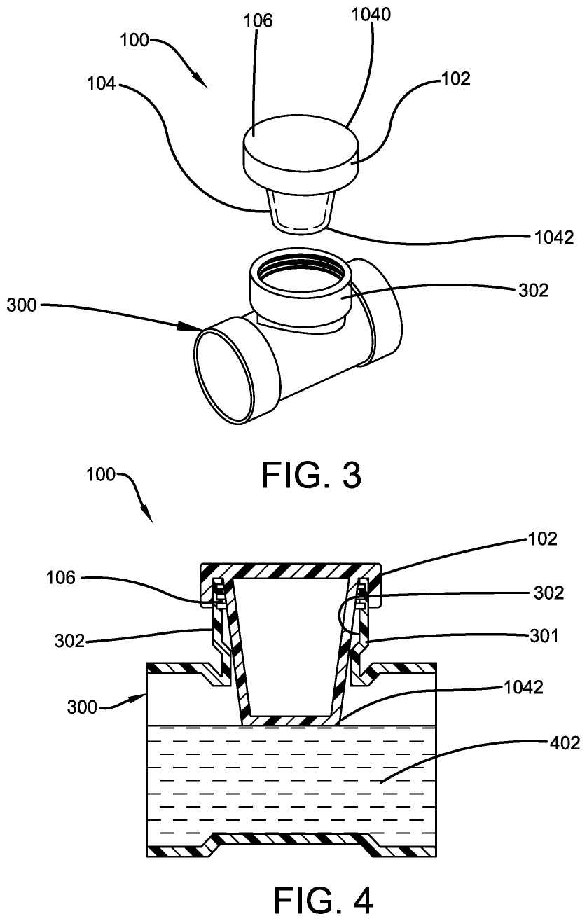

FIG. 3 illustrates a perspective view of one potential embodiment of the sewage backup prevention cap 100 of the present invention in accordance with the disclosed architecture, wherein the sewage backup prevention cap 100 is about to be loosely installed in a “T” shaped sewer connection or cleanout 300. More specifically, the generally “T” shaped sewer connection or cleanout 300 is comprised of a branch 310 and pair of legs 320, 322, wherein each of the pair of legs 320, 322 are generally in line with one another and the sewer line, and further wherein the branch 310 is generally perpendicular to the longitudinal axis of the pair of legs 320, 322 and the sewer line. The “T” shaped sewer connection or cleanout 300 is preferably comprised of a relatively lightweight and low-density polyethylene (LDPE), PVC or ABS plastic.

As also illustrated in FIG. 3, the diameter of the top portion top ring 120 of the cap 100 is wider than the diameter of the top branch opening 312, thereby allowing the top ring 120 to rest on the branch 310, wherein bottom surface 126 of the top ring 120 is in contact with the top surface 314 of the branch 310 and the body portion 110 extends downwardly into the opening 312 of the branch 310. This provides a relatively loose fit to the cap 100 when it is installed on/in the opening 312. Further, the tapered shape of the body portion 110 allows the air pocket 118 to be easily accommodated in the open space of the opening 312, and for the body portion 110 to float on the water/fluid flowing through the sewer pipe and the sewer “T” cleanout. The depth of the body portion 110 should be such that it extends through the branch 310 and near the center axis of the sewer pipe so that it can easily float and move upwards and downwards to periodically allow backed up sewage to exit the sewer cleanout device 300 at the branch opening 312.

FIG. 4 illustrates a cross-sectional view of one potential embodiment of the sewage backup prevention cap 100 of the present invention in accordance with the disclosed architecture, wherein the sewage backup prevention cap 100 is loosely installed in a “T” shaped sewer connection or cleanout 300 containing a flow of sewage 400. As shown, the top ring 120 of the cap device 100 covers the opening 312 and touches the top surface 314 of branch 310. Further, the tapered body portion 110 floats in the sewage 400 flowing within the sewage pipe and “T” cleanout 300. The floating nature of the integrated air pocket 118 allows the cap device 100 to be repositioned upward and downward in the branch opening 312 via the forces of gravity and/or buoyancy. Further, because the body portion 110 is tapered, as it moves upward (i.e., as if it were leaving the opening), the amount of space between the body portion 110 and the branch 310 increases to allow a larger volume of sewage 400 to pass therethrough. If the restriction in the sewer line clears, the cap 100 will drop back down into place via gravitational force.

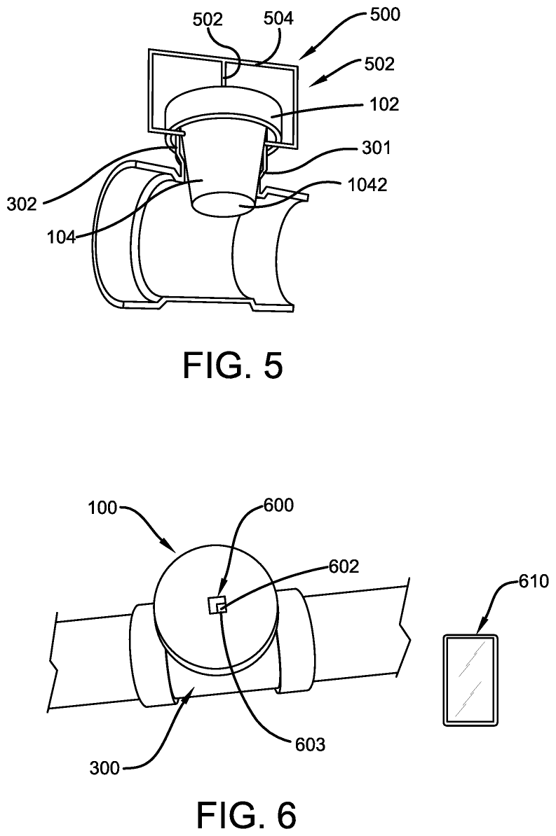

FIG. 5 illustrates a partial cross-sectional view of one potential embodiment of the sewage backup prevention cap 100 of the present invention in accordance with the disclosed architecture, wherein the entire sewage backup prevention cap 100 is shown to be loosely installed in a cross-sectioned branch member 310 of a generally “T” shaped sewer cleanout 300 and a cross sectioned motion limiting cage 500 is attached to the branch 310 of the cleanout 300 over top of the sewage backup prevention cap 100. More specifically, the cage 500 is preferably comprised of a wire frame formed from one or more vertical members 502 attached to one or more horizontal members 504. The one or more horizontal members 504 are positioned above the top surface 122 of the top ring 120 a sufficient distance to permit upward movement of the cap device 100 in the event of a sewer backup, but limit the cap's ability to completely be removed from the branch opening 310. The one or more vertical members 502 are attached to the horizontal member(s) 504 and extend downwardly therefrom to removably engage the cleanout device 300 to hold the cage in proper placement above and around the cap 100 (i.e., to prevent the cap from leaving the opening 312). The vertical members 502 should not otherwise interfere with the upward and downward movement of the cap 100 within the branch opening 312.

FIG. 6 illustrates a perspective view of one potential embodiment of the sewage backup prevention cap 100 of the present invention in accordance with the disclosed architecture, wherein the sewage backup prevention cap 100 is loosely installed in a “T” shaped sewer cleanout 300 installed along a sewer line, and further wherein a sensor 600 is positioned on a top surface 122 of the top ring 120. More specifically, the sensor 600 is capable of sensing movement of the cap 100 and is further comprised of a transmitter 602 that is in wireless communication with a remote device 604, such as a smartphone, smart watch, computer, tablet or the like. Further, the wireless communication means can be any wireless communication means known in the art such as, but not limited to, Bluetooth, RFID, NFC, 5G, etc. Therefore, when a sewage backup occurs that causes the novel cap 100 to reposition upward within the “T” shaped branch opening 312, the sensor 600, upon sensing the upward motion of the cap 100, will trigger the transmitter 602 to issue a wireless alert or other communication to the user's smart device 604 so that the user can begin to take corrective action before the sewage backup extends into the finished portion of the house or other building.

The sewage backup prevention cap 100 of the present invention can be used in residential, commercial, and industrial plumbing systems, and does not obstruct the flow of sewage through a sewer line. The cap 100 may be manufactured in a variety of different colors and/or designs, and may further comprise logos, indicia, trademarks, geometric patterns, customizable colors and fonts on its surface. In one embodiment, the overall height of the cap 100, as measured between the top surface 122 of the top ring 120 and the bottom surface 116 of the body portion 110, can range from 4″-7″. The diameter of the top ring 120 as measured between the side surfaces 124 can range in between 4″-6″.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sewage backup prevention cap”, “plumbing system attachment”, “sewage backflow stop cap”, “threadless cap”, and “cap” are interchangeable and refer to the sewage backup prevention cap 100 of the present invention.

Notwithstanding the forgoing, the sewage backup prevention cap 100 of the present invention can be of any suitable size and configuration as is known in the art without affecting the overall concept of the invention, provided that it accomplishes the above stated objectives. One of ordinary skill in the art will appreciate that the size, configuration and material of the sewage backup prevention cap 100 as shown in the FIGS. are for illustrative purposes only, and that many other sizes and shapes of the sewage backup prevention cap 100 are well within the scope of the present disclosure. Although the dimensions of the sewage backup prevention cap 100 are important design parameters for user convenience, the sewage backup prevention cap 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sewer backup prevention device comprising:
a sewer cleanout; and
a sewer cap comprised of a top ring and a body portion having an integrated air pocket.

2. The sewer backup prevent device as recited in claim 1, wherein the body portion is further comprised of an upper end having a first diameter and a lower end having a second diameter.

3. The sewer backup prevent device as recited in claim 2, wherein the first diameter is greater than the second diameter.

4. The sewer backup prevent device as recited in claim 3, wherein the sewer cleanout is comprised of a branch and a pair of legs.

5. The sewer backup prevent device as recited in claim 4, wherein each of the pair of legs share a common longitudinal axis.

6. The sewer backup prevent device as recited in claim 5, wherein the branch has an upper surface, an opening and a longitudinal axis that is substantially perpendicular to the common longitudinal axis.

7. The sewer backup prevent device as recited in claim 6, wherein the top ring of the sewer cap rests on the upper surface.

8. The sewer backup prevent device as recited in claim 7, wherein the body portion is positioned within the opening of the branch.

9. The sewer backup prevent device as recited in claim 8, wherein a flow of an effluent through the pair of legs causes the body portion of the sewer cap to be repositioned.

10. The sewer backup prevent device as recited in claim 1 further comprising a cage.

11. The sewer backup prevent device as recited in claim 10, wherein the cage is positioned over the sewer cap and is attached to the sewer cleanout

12. The sewer backup prevent device as recited in claim 9 further comprising a sensor that is capable of sensing a movement of the sewer cap.

13. The sewer backup prevent device as recited in claim 12, wherein the sensor comprises a transmitter in wireless communication with a remote device.

14. A sewer cleanout cap comprising:
a top ring having a first diameter; and
a body portion having an upper end having a second diameter, a lower end having a third diameter, and an integrated air pocket, wherein the sewer cleanout device is devoid of a thread.

15. The sewer cleanout cap as recited in claim 14, wherein the first diameter is greater than the second diameter and the third diameter.

16. The sewer cleanout cap as recited in claim 15, wherein the second diameter is greater than the third diameter.

17. The sewer cleanout cap as recited in claim 16, further comprising a sensor positioned on a top surface of the top ring, wherein the sensor is capable of sensing a movement of the sewer cleanout cap

18. The sewer cleanout cap as recited in claim 16, wherein the sensor comprises a transmitter in wireless communication with a remote device.

19. A sewer backup prevention system comprising:
a length of sewer;
a sewer cleanout positioned along and in line with the length of sewer, the sewer cleanout comprising a branch having an opening therein; and
a sewer cap positioned at least partially in the opening of the branch, wherein the sewer cap is comprised of a top ring having a first diameter and a tapered body portion having a variable diameter and an integrated air pocket, and further wherein the first diameter is greater than a largest diameter of the variable diameter.

20. The sewer backup prevention system as recited in claim 19, wherein a presence of a sufficient amount of sewage in the sewer line will cause the sewer cap to reposition itself relative to the branch.
